(19) United States
(12) Patent Application Publication
(10) Pub. No.: US 2025/0252954 A1
(43) Pub. Date: Aug. 7, 2025

(54) MACHINE LEARNING- BASED METHOD AND SYSTEM FOR ELIMINATING INFORMATION FROM INPUT FEATURES

(71) Applicant: National Tsing Hua University, Hsinchu (TW)

(72) Inventors: CHI-CHUN LEE, Hsinchu (TW); Chin-Po Chen, Hsinchu (TW); Wei-Tung Hsu, Hsinchu (TW)

(21) Appl. No.: 18/802,816

(22) Filed: Aug. 13, 2024

(30) Foreign Application Priority Data
Feb. 2, 2024 (TW) 113104304

(51) Int. Cl. G10L 15/22; G10L 15/16

(52) U.S. Cl. CPC G10L 15/22; G10L 15/16

(57) ABSTRACT

According to a method provided in the disclosure, based on an original signal and an information elimination (IE) model, a feature not including information allowing an attribute to be recognizable is generated. A task is then performed using a machine learning model based on the generated feature. For training the IE model, two adversarial networks are provided and a loss function is minimized. Input layers of the two adversarial networks are generated based on output layer and input features of the IE model. Generator of one adversarial network and discriminator of the other adversarial network are configured to perform the task, while discriminator of the one adversarial network and generator of the other adversarial network are configured to recognize the attribute. The loss function is associated with a disentangling loss of input layers of the two adversarial networks, as well as losses of each generator and discriminator.

### CROSS-REFERENCE TO RELATED APPLICATION

The present application claims the benefit of and priority to Taiwan Patent Application No. 113104304, filed on Feb. 2, 2024, the contents of which are hereby fully incorporated herein by reference for all purposes.

### FIELD

The present disclosure generally relates to machine learning technology and, more particularly, to methods and systems for eliminating information from input features.

### BACKGROUND

In the field of machine learning and data analysis, management and utilization of sensitive information have always been key issues, which are particularly important when dealing with data pertaining to vulnerable groups, such as patients with dementia or other cognitive impairments.

Traditionally, privacy protection methods, such as data encryption or attribute elimination, have been employed. Although data encryption is a common technique used to protect sensitive information, data encryption has limitations in data analysis and machine learning applications because encrypted data is often difficult to process or analyze. On the other hand, attribute elimination specifically targets certain sensitive or unnecessary attributes for complete removal from features. However, the known attribute elimination methods significantly weaken predictive power of a model when the removed attributes are related to the target variable.

Therefore, optimizing methods for filtering sensitive information remains a need and is one of the goals that professionals in the field are striving towards.

### SUMMARY

In view of the above, the present disclosure provides a machine learning-based method, that can effectively and efficiently eliminate information from input features, without sacrificing the overall data utility of the input features.

A first aspect of the present disclosure provides a computer-implemented method for training an information elimination model. The information elimination model is configured to eliminate, from an input feature, first information that allows a first attribute to be recognizable. The computer-implemented method includes providing the information elimination model, a first adversarial network, and a second adversarial network; and minimizing a loss function to train the information elimination model. Two input layers, including one input layer from each of the first adversarial network and the second adversarial network, are generated based on an output layer of the information elimination model and the input feature. The first adversarial network includes a first generator configured to perform a task and a first discriminator configured to recognize the first attribute. The second adversarial network includes a second generator configured to recognize the first attribute and a second discriminator configured to perform the task. The loss function is associated with a disentangling loss of the two input layers of the first adversarial network and the second adversarial network, a first loss of the first generator, a second loss of the first discriminator, a third loss of the second generator, and a fourth loss of the second discriminator.

In an implementation of the first aspect, the information elimination model is further configured to eliminate, from the input feature, second information that allows a second attribute to be recognizable. The computer-implemented method further includes providing a third adversarial network. An input layer of the third adversarial network is generated based on the output layer of the information elimination model and the input feature. The first adversarial network further includes a third discriminator configured to recognize the second attribute. The second adversarial network further includes a fourth discriminator configured to recognize the second attribute. The third adversarial network includes a third generator configured to recognize the second attribute, a fifth discriminator configured to recognize the first attribute, and a sixth discriminator configured to perform the task. The disentangling loss is further associated with the input layer of the third adversarial network, and the loss function is further associated with a fifth loss of the third generator, a sixth loss of the fifth discriminator, a seventh loss of the sixth discriminator, an eighth loss of the third discriminator, and a ninth loss of the fourth discriminator.

In another implementation of the first aspect, the output layer of the information elimination model includes a first control signal corresponding to the first adversarial network and a second control signal corresponding to the second adversarial network.

In yet another implementation of the first aspect, the information elimination model generates the first control signal and the second control signal using a Gumbel-Softmax function.

In yet another implementation of the first aspect, the first control signal generated by the information elimination model after training is configured to eliminate the first information from the input feature.

In yet another implementation of the first aspect, the computer-implemented method further includes providing a model configured to perform the task and taking the model as the first generator and the second discriminator; and providing a recognition model for the first attribute and taking the recognition model as the first discriminator and the second generator.

In yet another implementation of the first aspect, minimizing the loss function to train the information elimination model includes keeping a plurality of parameters of the first adversarial network and the second adversarial network unchanged when minimizing the loss function.

In yet another implementation of the first aspect, the first attribute includes an attribute related to vulnerable populations.

In yet another implementation of the first aspect, the first attribute includes an attribute of dementia.

In yet another implementation of the first aspect, the task includes a speech recognition-related task.

In yet another implementation of the first aspect, the task includes an automatic speech recognition.

In yet another implementation of the first aspect, a gradient reversal layer is included before each of the first discriminator and the second discriminator.

In yet another implementation of the first aspect, each of the second loss and the third loss includes a recall loss.

In yet another implementation of the first aspect, each of the first loss and the fourth loss includes a connectionist temporal classification loss.

A second aspect of the present disclosure, a computer-implemented method for performing a task based on a machine learning model is provided. The computer-implemented method includes receiving an original signal; generating a feature not including first information based on the original signal and an information elimination model, the first information allowing a first attribute to be recognizable; and performing the task based on the feature and the machine learning model. The information elimination model is trained by the computer-implemented method provided in the first aspect of the present disclosure.

A third aspect of the present disclosure provides a non-transitory computer-readable medium, including at least one instruction that, when executed by a processor of an electronic device, causes the electronic device to perform the computer-implemented method provided in the first aspect of the present disclosure.

### BRIEF DESCRIPTION OF THE DRAWINGS

FIG. 1 is a diagram illustrating an automatic speech recognition in accordance with an example implementation of the present disclosure.

FIG. 2 is a flowchart for performing a task by using a machine learning model in accordance with an example implementation of the present disclosure.

FIG. 3 is a flowchart for training an information elimination model in accordance with an example implementation of the present disclosure.

FIG. 4 is a diagram illustrating training of an information elimination model in accordance with an example implementation of the present disclosure.

FIG. 5 is a block diagram of a computing system in accordance with an example implementation of the present disclosure.

### DETAILED DESCRIPTION

The following will refer to the relevant drawings to describe implementations of a machine learning-based method in the present disclosure, in which the same components will be identified by the same reference symbols.

The following description includes specific information regarding the exemplary implementations of the present disclosure. The accompanying detailed description and drawings of the present disclosure are intended to illustrate the exemplary implementations only. However, the present disclosure is not limited to these exemplary implementations. Those skilled in the art will appreciate that various modifications and alternative implementations of the present disclosure are possible. In addition, the drawings and examples in the present disclosure are generally not drawn to scale and do not correspond to actual relative sizes.

The term “couple” is defined as a connection, whether direct or indirect, through an intermediate component, and is not necessarily limited to a physical connection. When the terms “comprising” or “including” are used, they mean “including but not limited to,” and explicitly indicate an open relationship between the combination, group, series, and the like.

The present disclosure provides a training method that may enhance the accuracy of machine learning models. It should be noted that while several implementations of the present disclosure are exemplified through the Speech Emotion Recognition (SER) model, the training method is not limited to any specific machine learning model. Those skilled in the art may apply the training method to any desired machine learning model based on the technical concepts introduced in these implementations.

The present disclosure provides a computer-implemented method that may perform task(s) based on machine learning model(s). The method may eliminate information to be eliminated (e.g., sensitive information) from the input feature(s) before executing the task(s) by the machine learning model(s), while maintaining reliable task execution accuracy. It should be noted that in several implementations of the present disclosure, Automatic Speech Recognition (ASR) is used as an example of the task(s). Information related to vulnerable populations (such as but not limited to, dementia) is used, as an example of the information to be eliminated, for illustrative purposes. However, the present disclosure is not limited to the examples provided herein, as one of skilled in the art may apply the computer-implemented method provided by the present disclosure to various models based on the techniques introduced in these implementations.

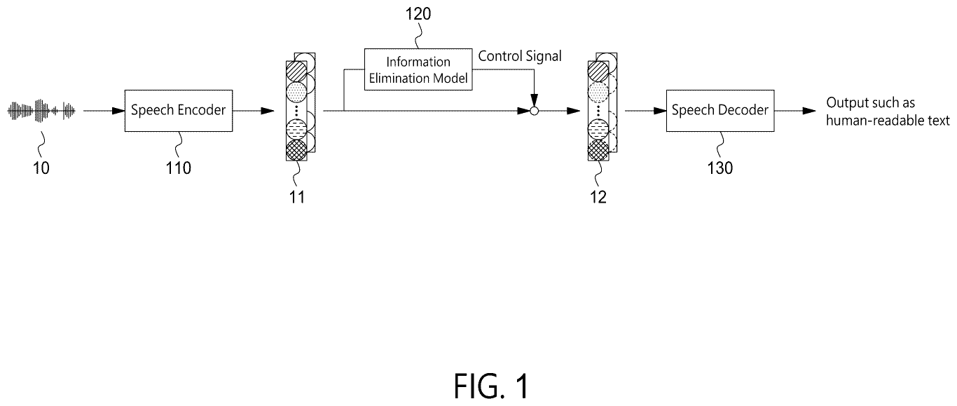

FIG. 1 is a diagram illustrating an automatic speech recognition in accordance with an example implementation of the present disclosure.

Referring to FIG. 1, an automatic speech recognition system 1 may include an audio encoder 110, an information elimination model 120, and an audio decoder 130.

The speech encoder 110 may convert an original audio signal 10 into multiple speech features (e.g., first speech features 11). In some implementations, the speech encoder 110 may include a manually designed feature extractor. In some implementations, the speech encoder 110 may include a deep learning network. For example, the speech features may be features extracted from the original audio signal 10 using acoustic feature extraction (e.g., eGeMAPS feature extraction). For example, the speech encoder 110 may include, but is not limited to, models such as data2vec, wav2vec, vq-wav2vec, HuBert, Whisper, or their combinations. Furthermore, the number of speech features may be related to a length of the original audio signal 10.

The information elimination model 120 may be configured to eliminate first information contained in the input features. In some implementations, the information elimination model 120 may generate a control signal to filter out the first information from the input features (e.g., the first speech features 11), thus obtaining speech features (e.g., second speech features 12) that do not include the first information.

Specifically, the first information may be the information that allows a first attribute recognizable in the input features. For example, when the first attribute relates to dementia, the input features containing the first information may be used to recognize dementia. In a case that the first information has been eliminated from the input features, it is unable to recognize dementia from the speech features that do not contain the first information.

The speech decoder 130 may be configured to generate corresponding human-readable text or other forms of output based on the speech features (e.g., the second speech features 12). For example, the speech decoder 130 may include a machine learning models such as a Recurrent Neural Network (RNN) model.

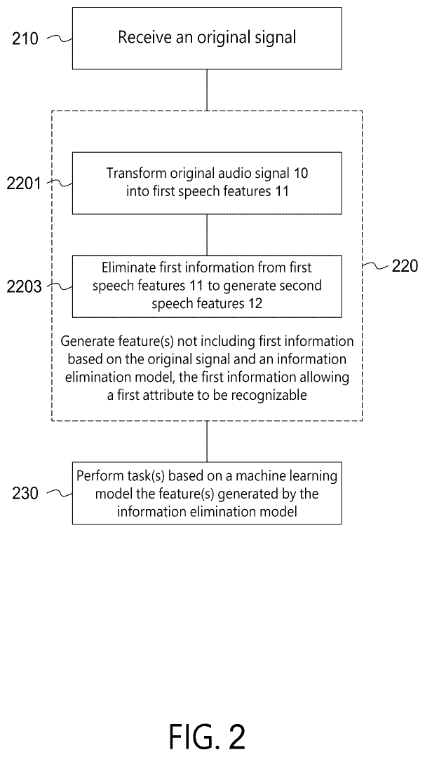

FIG. 2 is a flowchart for performing a task by using a machine learning model in accordance with an example implementation of the present disclosure. The process in FIG. 2 is applicable to the automatic speech recognition system 1 of the implementation in FIG. 1, and the following implementations will be described with the automatic speech recognition system 1.

Referring to FIG. 2, in operation 210, an original signal may be received.

In some implementations, the speech encoder 110 may receive an original audio signal 10. However, the present disclosure does not limit the source of the original signal to the examples provided herein (e.g., the original audio signal 10). The original signal may be, for example, input by a user through input devices such as microphones, or may be, for example, captured from a sound signal in video clips.

In operation 220, based on the original signal and the information elimination model, feature(s) that do not include the first information may be generated, where the first information may be the information that allows a first attribute to be recognizable.

For example, the first attribute may be an attribute of dementia, and the features containing the first information may allow dementia recognizable from the features.

In some implementations, the operation 220 may be completed by the cooperation of the speech encoder 110 and the information elimination model 120, including operations 2201 and 2203. In operation 2201, the speech encoder 110 may transform the original audio signal 10 into the first speech feature(s) 11, and in operation 2203, the information elimination model 120 may generate a control signal to eliminate the first information in the first speech feature(s) 11, and obtain the second speech feature(s) 12, which does not include the first information.

In some implementations, the speech encoder 110 may transform the original audio signal 10 into the first speech feature(s) 11 that include multiple feature vectors, and the information elimination model 120 may generate a control signal for each feature vector. Each control signal may transform the corresponding feature vector into a feature vector that does not include the first information. Therefore, based on the corresponding control signals, the automatic speech recognition system 1 may transform multiple feature vectors in the first speech feature(s) 11 into the second speech feature(s) 12, which include multiple feature vectors that do not include the first information.

In some implementations, the control signal may be a signal with values of 0 or 1 and the same dimension as the corresponding feature vector, thus the entrywise product of the control signal with the corresponding feature vector may be a feature vector that does not include the first information.

In operation 230, based on the features generated by the information elimination model and on the machine learning model, a task may be performed.

In some implementations, the machine learning model may include the speech decoder 130, and the task may be, for example, automatic speech recognition that converts the second speech feature(s) 12 generated by the information elimination model 120 into human-readable text or other outputs.

Through the methods introduced in the implementations of FIGS. 1 and 2, even if another user can access the input of the machine learning model, the other user cannot recognize the first attribute from such input. For example, in end-to-end machine learning scenarios, such as automatic speech recognition, even if the other user can access the input features of the speech decoder, the other user cannot recognize information related to vulnerable populations, such as dementia from the input features. Therefore, while performing automatic speech recognition, sensitive information may be protected.

The following describes implementations of training the information elimination model 120.

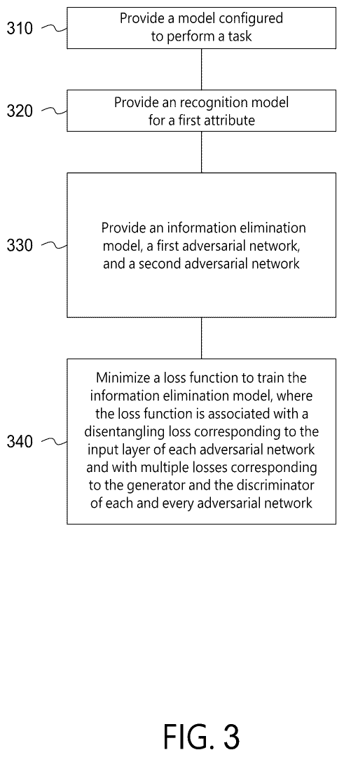

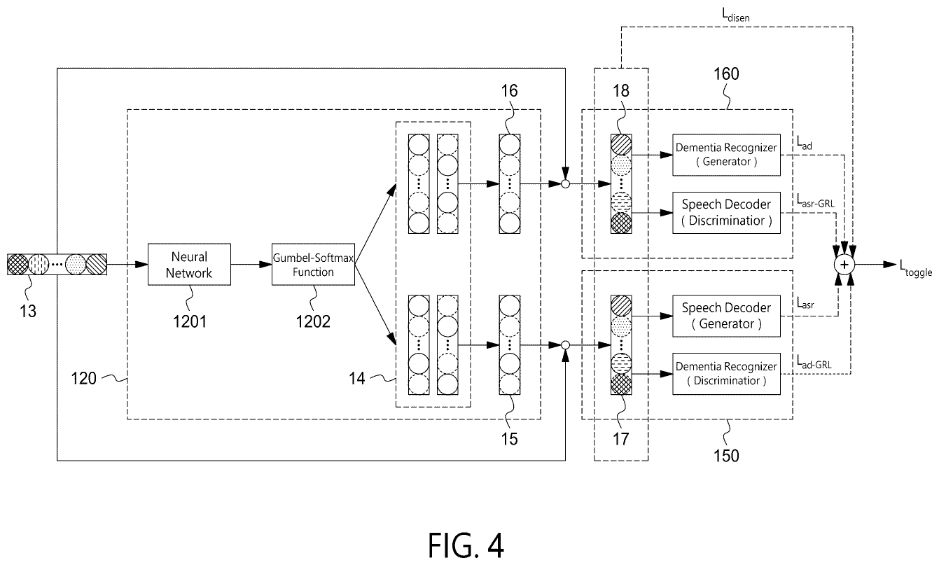

FIG. 3 is a flowchart for training an information elimination model in accordance with an example implementation of the present disclosure. FIG. 4 illustrates a diagram of a training of an information elimination model in accordance with an example implementation of the present disclosure.

Referring to FIG. 3 and FIG. 4, in operation 310, a model for performing a task may be provided. Specifically, the task may be a specific task to be performed by the machine learning model under the application scenario of the information elimination model 120.

For example, referring to FIG. 1, the information elimination model 120 may be configured to eliminate the first information in the first speech feature(s) 11 for the speech decoder 130 to perform automatic speech recognition. Therefore, the model for performing the task may be the speech decoder 130, for example.

In some implementations, in addition to the speech decoder 130, the speech encoder 110 may be also provided. Here, the speech encoder 110 and the speech decoder 130 may be pre-trained, for example, using existing automatic speech recognition encoders and decoders, but not limited to the examples provided herein. For example, the speech encoder 110 and the speech decoder 130 may be those that have been fine-tuned using a dataset prepared by the user (e.g., the ADReSS dataset) based on existing automatic speech recognition encoders and decoders (e.g., the Data2Vec-Audio-Large-960h model provided by HUGGING FACE®).

In operation 320, a recognition model for the first attribute is provided. Specifically, the recognition model may be configured to recognize the first attribute, that is, to recognize whether the input features are associated with the first attribute. For example, the recognition model may be a dementia recognizer or another machine learning model that may recognize dementia based on input features.

In some implementations, the information elimination model 120 may output one or more control signals to eliminate one or more pieces of information in the input features that allow one or more attributes to be recognizable, and the operation 320 may provide a recognition model for each attribute. For example, the information elimination model 120 may be also configured to eliminate second information that allows a second attribute to be recognizable. Therefore, the operation 320 may also provide a recognition model for recognizing the second attribute, and so forth.

In some implementations, the recognition models for all attributes may be provided in the operation 320 after being trained separately. However, the specific training methods are not within the scope of the present disclosure, as one of skilled in the art may implement according to their conditions or needs, hence are not elaborated here.

In operation 330, the information elimination model 120, the first adversarial network 150, and the second adversarial network 160 may be provided.

Specifically, in the operation 330, multiple (e.g., B+1) adversarial networks provided may correspond to the task and the attributes corresponding to the information to be eliminated (e.g., B attributes). In detail, the first adversarial network 150 may correspond to the task. Therefore, the generator of the first adversarial network 150 may include the model for performing the task, and one or more discriminators of the first adversarial network 150 may include one or more recognition models configured to recognize one or more attributes corresponding to one or more pieces of information to be eliminated. In addition, the second adversarial network 160 may correspond to the first attribute. Therefore, the generator of the second adversarial network 160 may include the recognition model configured to recognize the first attribute, one of the discriminator(s) of the second adversarial network 160 may include the model for performing the task, and other discriminator(s) may include recognition model(s) configured to recognize other attribute(s) corresponding to the information to be eliminated, and so forth.

In some implementations, before each discriminator of the adversarial networks, a gradient reversal layer (GRL) may be included.

For example, when the task is speech decoding, and the information to be eliminated includes information (e.g., first information) that makes dementia (e.g., the first attribute) recognizable, the generators of the first adversarial network 150 and the second adversarial network 160 may respectively be the speech decoder 130 and the dementia recognizer 140, the discriminator of the first adversarial network may include the dementia recognizer 140, and the discriminator of the second adversarial network 160 may include the speech decoder 130.

For example, when the information to be eliminated further includes second information that makes a second attribute recognizable, the operation 330 may further provide a third adversarial network corresponding to the second information. In this case, the discriminators of the first adversarial network 150 and the second adversarial network 160 may further include recognition models configured to recognize the second attribute. Additionally, the generator of the third adversarial network may include a recognition model configured to recognize the second attribute, and the discriminators of the third adversarial network may include the model for performing the task and the recognition model configured to recognize the first attribute.

Referring to FIG. 4, during the training of the information elimination model 120, a single input data may, for example, include a feature vector 13 with a dimension D, and the output may, for example, include B+1 control signals 15, 16 each with a dimension D, where B is the number of the attributes.

In some implementations, the information elimination model 120 may include a neural network 1201 with an output dimension of 2*(B+1)*D. However, for simplicity, the following implementations describe the case where only the first attribute is included (e.g., B=1). Implementations that extend to other attributes may be deduced by those skilled in the art based on the description of the implementations, hence are not specifically elaborated.

In some implementations, the 2*(B+1)*D-dimensional output of the neural network 1201 may be transformed, through a Gumbel-Softmax function 1202, into a 2*(B+1)*D-dimensional vector 14 (e.g., values of 0 or 1), and in which, an 1*(B+1)*D-dimensional vector may serve as the output of the information elimination model 120. In other words, the output layer of the information elimination model 120 may include an 1*(B+1)*D-dimensional vector, or include B+1 numbers of D-dimensional vectors.

In some implementations, the two vectors (e.g., B+1 vectors) included in the output layer of the information elimination model 120 may respectively serve as the first control signal 15 corresponding to the first adversarial network 150 and the second control signal 16 corresponding to the second adversarial network 160.

In some implementations, the input layers of the B+1 adversarial networks provided in the operation 330 may be generated from the feature vector 13 through the B+1 control signals. Specifically, the input layer of the first adversarial network 150 may be generated from the feature vector 13 through the first control signal 15. For example, the entrywise product of the feature vector 13 and the first control signal 15 may serve as the input feature 17 for the generator and B discriminators of the first adversarial network 150. The input layer of the second adversarial network 160 may be generated from the feature vector 13 through the second control signal 16. For example, the entrywise product of the feature vector 13 and the second control signal 16 may serve as the input feature 18 for the generator and B discriminators of the second adversarial network 160.

Based on the above descriptions, the operation 330 may provide the required architecture for training the information elimination network 120.

In operation 340, a loss function L_{toggle} may be minimized to train the information elimination model 120. Specifically, the loss function L_{toggle} may be associated with the disentangling loss corresponding to the input layers of each adversarial network (e.g., including the first adversarial network 150 and the second adversarial network 160), as well as associated with the multiple losses corresponding to each generator and discriminator in each and every adversarial networks.

Specifically, the disentangling loss may be used to decompose the complex interwoven features in data into independent and meaningful features. By minimizing the disentangling loss, the differences between features of different categories may be increased, while the differences within the same category may be reduced. In some implementations, the disentangling loss may be a diversity loss, for example.

In some implementations, the information elimination model 120 may output one or more control signals to eliminate one or more pieces of information in the input features that allow one or more attributes to be recognizable, and the loss function L_{toggle} may be associated with the disentangling loss corresponding to the input layers of multiple adversarial networks, as well as associated with the losses corresponding to each generator and discriminator.

For example, referring to FIG. 4, the loss function L_{toggle} may be associated (e.g., positively correlated) with disentangling losses L_{disen} of the input features 17, 18 of the first adversarial network 150 and the second adversarial network 160. Additionally, the loss function L_{toggle} may be also associated (e.g., positively correlated) with a loss Lₐₛᵣ of the generator of the first adversarial network 150, a loss L_{ad} of the generator of the second adversarial network 160, a loss L_{ad-GRL} of the discriminator of the first adversarial network 150, and a loss L_{asr-GRL} of the discriminator of the second adversarial network 160.

For example, the loss function L_{toggle} may be obtained by the following equation:

L_{toggle}=(Lₐₛᵣ+L_{ad-GRL})+(L_{ad}+L_{asr-GRL})+L_{disen}.

Having the loss function L_{toggle} be positively associated with the disentangling loss L_{disen} may increase the differences in input features of each adversarial network, thus reducing the recognition rate of each attribute while being able to perform the task. Advantageously, when the attributes are related to vulnerable populations, having the loss function L_{toggle} be positively with the disentangling loss L_{disen} may enhance the protection of vulnerable populations.

In some implementations, when the model is the speech decoder 130, the corresponding losses (e.g., loss Lₐₛᵣ and loss L_{asr-GRL}) may be, for example, the Connectionist Temporal Classification (CTC) loss. However, the present disclosure is not limited to the examples provided herein, as those skilled in the art may replace the CTC loss with other losses according to their needs.

In some implementations, when the model is the dementia recognizer 140, the corresponding losses (e.g., loss L_{ad} and loss L_{ad-GRL}) may be, for example, recall losses, to strengthen the protection of vulnerable populations.

In some implementations, the training set used for training the information elimination model 120 may include multiple audio data and corresponding multiple labeled texts. Based on each piece of audio data, depending on the length, the speech encoder 110 may generate multiple (e.g., T) D-dimensional feature vectors 13. Each feature vector 13 may be input into the information elimination model 120, the first control signal 15 and the second control signal 16 may be obtained. Using the first control signal 15 and the second control signal 16, the feature vector 13 may be transformed (e.g., by entrywise multiplication) into input features 17, 18. Accordingly, multiple (e.g., T) input features 17, 18 may be obtained. The input features 17 may serve as the input for the generator and discriminator of the first adversarial network 150 to calculate the losses Lₐₛᵣ and L_{ad-GRL}; the input features 18 may serve as the input for the generator and discriminator of the second adversarial network 160 to calculate the losses L_{ad} and L_{asr-GRL}. By traversing the training set in this manner, the information elimination model 120 may be trained by minimizing the loss function L_{toggle}.

It is worth mentioning that the information elimination model 120 trained through the described training architecture may use the first control signal 15 to eliminate the first information in the input features of the information elimination model 120.

For example, because the training purpose of the first adversarial network 150 is to enable the speech decoder 130 to correctly perform speech recognition in a situation where the dementia recognizer 140 is unable to recognize dementia. Therefore, the trained information elimination model 120 may use the first control signal 15 to eliminate the first information in the input features (e.g., the first speech features 11) of the information elimination model 120, and output features (e.g., the second speech features 12) from which dementia is unable to be recognized.

Table 1 below shows the performance of the information elimination model 120, trained according to the implementation(s) of the present disclosure, within the automatic speech recognition system 1 in terms of Word Error Rate (WER) and Dementia Protection Efficacy (DPE) scores, using the ADRESS dataset.

TABLE 1

| | WER | DPE(%) |
|---|---|---|
| Fine-tune | 0.257 | — |
| FSM | 0.259 | −5.56 |
| Automatic Speech Recognition System 1 | 0.257 | 33.33 |

In Table 1, “Fine-tune” refers to the automatic speech recognition model fine-tuned using the ADRESS dataset based on the Data2Vec-Audio-Large-960h model provided by huggingface; “FSM” is the “Feature Scoring Machine” architecture published in 2022 by Yu-Lin Huang, Bo-Hao Su, Y.-W. Peter Hong, and Chi-Chun Lee in “An Attention-Based Method for Guiding Attribute-Aligned Speech Representation Learning”; and Automatic Speech Recognition System 1, for example, includes the information elimination model 120 trained according to the implementation(s) of the present disclosure.

From Table 1, Automatic Speech Recognition System 1 has significantly improved in terms of Dementia Protection Efficacy, while maintaining a good Word Error Rate.

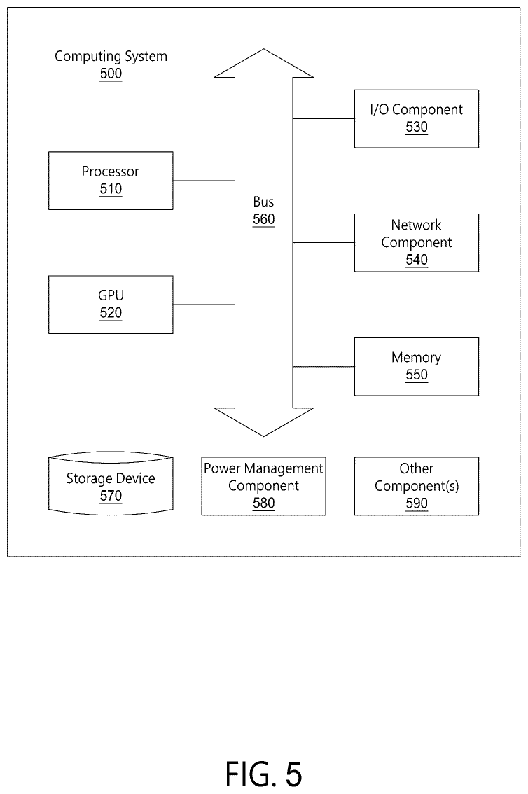

FIG. 5 is a block diagram of a computing system in accordance with an example implementation of the present disclosure.

Referring to FIG. 5, computer-implemented methods, such as methods for training the machine learning model and for performing task(s) based on machine learning model(s) that are introduced in the present disclosure, as well as other computer-implemented methods, may be implemented on a computing system 500 with various hardware components. In some implementations, the computing system 500 may be implemented in the form of an electronic device, which may include, but is not limited to, one or more of the following components: a processor (e.g., Central Processing Unit (CPU)) 510, a processor (Graphics Processing Unit, GPU) 520, input/output components 530, network components 540, and a memory 550. These components may communicate and transfer data via a system bus 560. However, the present disclosure does not limit the specific models, quantities, and configurations of these components. Those skilled in the art can adjust, select, or add/subtract components based on the specific requirements and operating environment when implementation.

In some implementations, the primary computing core inside the computing system 500 is one or more processors 510. This processor 510 may be responsible for running the main computational processes and related control logic of algorithms such as deep learning. In some implementations, the processor 510 may be configured to execute processing instructions (e.g., machine/computer-executable instructions) stored in non-volatile computer-readable media (e.g., storage device 570).

In some implementations, to enhance the computational efficiency of deep learning, the computing system 500 may also include one or more graphics processing unis 520 designed for massive parallel computations. The graphics processing unit 520 may effectively improve the system's computational capacity during deep learning training and inference.

In some implementations, the computing system 500 may include various input/output components 530 configured to receive user input and display system output. For example, the input/output components 530 may include a keyboard, mouse, touchpad, display screen, speakers, and other types of sensing devices.

In some implementations, the computing system 500 may also include network components 540 configured for network communication. For example, the network component 540 may include a network interface card for wired or wireless network connections, or communication modules for 3G, 4G, 5G, or other wireless communication technologies.

In some implementations, the computing system 500 may include one or more memory components 550, such as volatile memory components like Random Access Memory (RAM). The memory 550 may store the parameters of the deep learning model, as well as other data and programs used to run algorithms like deep learning.

Furthermore, the computing system 500 may also include one or more of the following components: storage devices 570, power management components 580, and other (e.g., hardware) components 590.

In some implementations, the computing system 500 may include one or more storage devices 570, such as non-volatile memory components like Hard Disk Drive (HDD) or Solid State Drive (SSD). The storage devices 570 may be configured to store the code of deep learning software, training data, model parameters, etc. Additionally, storage devices 570 may also be configured to store intermediate results and final outputs of algorithms like deep learning.

In some implementations, the computing system 500 may include one or more power management components 580, configured to provide power to various hardware components of the computing system 500 and manage their power consumptions. This power management component 580 may include batteries, power converters, and other power management devices.

In some implementations, the computing system 500 may also include other (e.g., hardware) components 590, such as cooling fans, heat dissipators, and other various control and monitoring devices. The present disclosure is not limited in this regard.

Additionally, implementations of the present disclosure may also be implemented as one or more computer program products or one or more non-transitory computer-readable medium, which include one or more instructions of a computer program. Specifically, the computer program (also referred to as a program, software, script, or code) may be presented in any form of programming language and can be deployed in any form. During the operation of the computing system 500 (e.g., electronic device), the instructions or part of them may reside entirely or at least partially inside the processor 510, allowing the processor 510 to execute the methods introduced in the disclosure.

In summary, the method, device, and non-transitory computer-readable medium for training a machine learning model provided in the implementations of the present disclosure involve dynamically adjusting the data distribution of the training set, based on the evaluation results of the validation set, during the training process. Consequently, the robustness of the trained machine learning model may be enhanced, thus enabling the trained machine learning model to perform well on input data with various levels of noise.

Based on the above description, it is apparent that various techniques can be configured to implement the concepts described in this application without departing from their scope. Furthermore, although certain implementations have been specifically described and illustrated, those skilled in the art will recognize that variations and modifications can be made in form and detail without departing from the scope of the concepts. Thus, the described implementations are to be considered in all respects as illustrative and not restrictive. Moreover, it should be understood that this application is not limited to the specific implementations described above, but many rearrangements, modifications, and substitutions can be made within the scope of the present disclosure.

What is claimed is:

1. A computer-implemented method for training an information elimination model, the information elimination model configured to eliminate, from an input feature, first information that allows a first attribute to be recognizable, the computer-implemented method comprising:
providing the information elimination model, a first adversarial network, and a second adversarial network; and
minimizing a loss function to train the information elimination model, wherein
two input layers, including one input layer from each of the first adversarial network and the second adversarial network, are generated based on an output layer of the information elimination model and the input feature,
the first adversarial network comprises:
a first generator configured to perform a task; and
a first discriminator configured to recognize the first attribute,
the second adversarial network comprises:
a second generator configured to recognize the first attribute; and
a second discriminator, configured to perform the task, and
the loss function is associated with a disentangling loss of the two input layers of the first adversarial network and the second adversarial network, a first loss of the first generator, a second loss of the first discriminator, a third loss of the second generator, and a fourth loss of the second discriminator.

2. The computer-implemented method of claim 1, wherein the information elimination model is further configured to eliminate, from the input feature, second information that allows a second attribute to be recognizable, and the computer-implemented method further comprises:
providing a third adversarial network, wherein
an input layer of the third adversarial network is generated based on the output layer of the information elimination model and the input feature,
the first adversarial network further comprises a third discriminator configured to recognize the second attribute,
the second adversarial network further comprises a fourth discriminator configured to recognize the second attribute,
the third adversarial network comprises:
a third generator configured to recognize the second attribute;
a fifth discriminator configured to recognize the first attribute; and
a sixth discriminator configured to perform the task,
the disentangling loss is further associated with the input layer of the third adversarial network, and
the loss function is further associated with a fifth loss of the third generator, a sixth loss of the fifth discriminator, a seventh loss of the sixth discriminator, an eighth loss of the third discriminator, and a nineth loss of the fourth discriminator.

3. The computer-implemented method of claim 1, wherein the output layer of the information elimination model comprises a first control signal corresponding to the first adversarial network and a second control signal corresponding to the second adversarial network.

4. The computer-implemented method of claim 3, wherein the information elimination model generates the first control signal and the second control signal using a Gumbel-Softmax function.

5. The computer-implemented method of claim 3, wherein the first control signal generated by the information elimination model after training is configured to eliminate the first information from the input feature.

6. The computer-implemented method of claim 1, further comprising:
providing a model configured to perform the task and taking the model as the first generator and the second discriminator; and
providing a recognition model for the first attribute and taking the recognition model as the first discriminator and the second generator.

7. The computer-implemented method of claim 1, wherein minimizing the loss function to train the information elimination model comprises:
keeping a plurality of parameters of the first adversarial network and the second adversarial network unchanged when minimizing the loss function.

8. The computer-implemented method of claim 1, wherein the first attribute comprises an attribute related to vulnerable populations.

9. The computer-implemented method of claim 8, wherein the first attribute comprises an attribute of dementia.

10. The computer-implemented method of claim 1, wherein the task comprises a speech recognition-related task.

11. The computer-implemented method of claim 10, wherein the task comprises an automatic speech recognition.

12. The computer-implemented method of claim 1, wherein a gradient reversal layer is included before each of the first discriminator and the second discriminator.

13. The computer-implemented method of claim 1, wherein each of the second loss and the third loss comprises a recall loss.

14. The computer-implemented method of claim 1, wherein each of the first loss and the fourth loss comprises a connectionist temporal classification loss.

15. A computer-implemented method for performing a task based on a machine learning model, the computer-implemented method comprising:
receiving an original signal;
generating a feature not including first information based on the original signal and an information elimination model, the first information allowing a first attribute to be recognizable; and
performing the task based on the feature and the machine learning model, wherein
the information elimination model is trained by:
providing the information elimination model, a first adversarial network, and a second adversarial network; and
minimizing a loss function to train the information elimination model,
two input layers, including one input layer from each of the first adversarial network and the second adversarial network, are generated based on an output layer of the information elimination model and an input feature,
the first adversarial network comprises:
a first generator configured to perform the task; and
a first discriminator configured to recognize the first attribute,
the second adversarial network comprises:
a second generator configured to recognize the first attribute; and
a second discriminator configured to perform the task, and
the loss function is associated with a disentangling loss of the two input layers of the first adversarial network and the second adversarial network, a first loss of the first generator, a second loss of the first discriminator, a third loss of the second generator, and a fourth loss of the second discriminator.

16. A non-transitory computer-readable medium comprising at least one instruction that, when executed by a processor of an electronic device, causes the electronic device to:
provide an information elimination model, a first adversarial network, and a second adversarial network; and
minimize a loss function to train the information elimination model, wherein
two input layers, including one input layer from each of the first adversarial network and the second adversarial network, are generated based on an output layer of the information elimination model and an input feature,
the first adversarial network comprises:
a first generator configured to perform a task; and
a first discriminator configured to recognize a first attribute,
the second adversarial network comprises:
a second generator configured to recognize the first attribute; and
a second discriminator configured to perform the task, and
the loss function is associated with a disentangling loss of the two input layers of the first adversarial network and the second adversarial network, a first loss of the first generator, a second loss of the first discriminator, a third loss of the second generator, and a fourth loss of the second discriminator.
